(19) United States
(12) Patent Application Publication
(10) Pub. No.: US 2020/0123062 A1
(43) Pub. Date: Apr. 23, 2020

(54) METHOD AND COMPOSITION FOR PRODUCING SILICON-CARBIDE CONTAINING THREE-DIMENSIONAL OBJECTS

(71) Applicant: PSC Technologies GmbH, Berlin (DE)

(72) Inventors: Siegmund GREULICH-WEBER, Bad Lippspringe (DE); Rüdiger SCHLEICHER-TAPPESER, Berlin (DE)

(73) Assignee: PSC Technologies GmbH, Berlin (DE)

(21) Appl. No.: 16/612,516

(22) PCT Filed: May 9, 2018
(86) PCT No.: PCT/EP2018/062007

§ 371 Date: Nov. 11, 2019

(30) Foreign Application Priority Data
May 12, 2017 (DE) 1020171103627

(51) Int. Cl. C04B 35/571; C04B 35/573; C04B 35/624; C04B 35/626; B05D 3/06

(52) U.S. Cl. CPC C04B 35/571; C04B 35/573; C04B 35/624; B33Y 70/00; C04B 35/62625; C04B 35/62655; B05D 3/06; C04B 35/6265

(57) ABSTRACT

The invention relates to a method for producing three-dimensional objects, in particular workpieces, made from silicon-carbide containing compounds, in particular material, by means of additive manufacturing.

### CROSS-REFERENCES TO RELATED APPLICATIONS

This application is a National Stage filing of International Application PCT/EP 2018/062007, filed May 9, 2018, entitled METHOD AND COMPOSITION FOR PRODUCING SILICON-CARBIDE CONTAINING THREE-DIMENSIONAL OBJECTS, claiming priority to DE 10 2017 110 362.7, filed May 12, 2017. The subject application claims priority to PCT/EP 2018/062007and to DE 10 2017 110 362.7and incorporates all by reference herein, in their entirety.

### BACKGROUND OF THE INVENTION

The present invention relates to the technical field of generative manufacturing methods, in particular additive manufacturing.

In particular, the present invention relates to a method for the production of three-dimensional objects from compounds containing silicon carbide as well as a composition, in particular a precursor granulate, for the production of three-dimensional objects containing silicon carbide.

Moreover, the present invention relates to the use of a composition for the production of three-dimensional objects containing silicon carbide.

Furthermore, the present invention relates to a method for the production of a composition, in particular a precursor granulate.

Finally, the present invention relates to three-dimensional objects containing silicon carbide.

Generative manufacturing processes, also known as additive manufacturing (AM), are processes for the rapid production of models, patterns, tools and products from formless materials such as liquids, gels, pastes or powders.

Originally, generative manufacturing processes, in particular additive manufacturing, were generally referred to as 3D printing or rapid prototyping. However, these terms are now only used for special types of generative manufacturing processes. Generative manufacturing methods are used both for the production of objects from inorganic materials, in particular metals and ceramics, and from organic materials.

Preferably high-energy methods such as selective laser melting, electron beam melting or build-up welding are used for the production of objects made of inorganic materials, since the reactants or precursors used react or melt only at a higher energy input.

In principle, additive manufacturing enables the rapid production of highly complex components, but the production of components from inorganic materials in particular poses a number of challenges to both the starting and the product materials: For example, the starting materials, or reactants, should only react in a predetermined manner under the influence of energy, and disturbing side reactions must be ruled out in particular. Furthermore, under the influence of energy, for example, no segregation of the products or a phase separation or decomposition of the products may occur.

An exceptionally interesting and versatile material for ceramic materials and semiconductor applications is silicon carbide, also known as carborundum. Silicon carbide, with the chemical formula SiC, has an extremely high hardness and a high sublimation point and is frequently used as an abrasive or insulator in high-temperature reactors. Silicon carbide also forms alloys or alloy-like compounds with a variety of elements and compounds, which have a variety of advantageous material properties, such as high hardness, high resistance, low weight and low oxidation sensitivity even at high temperatures.

Silicon carbide-containing materials are usually sintered at high temperatures, resulting in relatively porous objects suitable only for a limited number of applications.

The properties of the porous silicon carbide material produced by conventional sintering processes do not correspond to those of compact crystalline silicon carbide, so that the advantageous properties of silicon carbide cannot be fully exploited.

In addition, silicon carbide—depending on the crystal type—does not melt but sublimes at high temperatures in the range between 2,300 and 2,700° C., i.e. it changes from a solid to a gaseous state of aggregation. This renders silicon carbide particularly unsuitable for additive manufacturing processes such as laser melting.

Due to the versatility of silicon carbide and the large number of beneficial application properties, attempts were nevertheless made to process silicon carbide using generative manufacturing processes.

For example, the German patent application DE10 2015 105 085 A1 describes a process for the production of objects from silicon carbide crystals, wherein the silicon carbide is obtained in particular by laser radiation from suitable carbon and silicon containing precursor compounds. When the laser beam is applied, the precursor compounds decompose selectively and silicon carbide is formed without the silicon carbide sublimating.

While the process described in DE 10 2015 105 085 A1 is perfectly suitable for obtaining objects from silicon carbide crystallites, a process and suitable starting compounds for producing a wide range of silicon carbide-containing compounds is still missing. In particular, it has not yet been possible to produce three-dimensional objects containing silicon carbide via additive manufacturing by employing a suitable selection of reactants, whose mechanical properties can be specially adapted to the respective application purpose.

### BRIEF SUMMARY OF THE INVENTION

It is therefore an objective of the present invention to avoid or at least reduce the disadvantages and problems associated with the state of the art described above.

In particular, one objective of the present invention is to provide a method which allows the production of three-dimensional objects containing silicon carbide by additive manufacturing, in which the properties of the silicon carbide-containing material are adapted to the respective application purpose.

A further objective of the present invention is to provide suitable precursor materials which can be easily and universally processed to desired silicon carbide-containing compounds, especially high-performance ceramics and silicon carbide alloys.

Subject-matter of the present invention according to a first aspect of the present invention is a method for the production of three-dimensional objects from silicon carbide-containing compounds; further advantageous embodiments of this aspect of the invention are provided.

A further subject-matter of the present invention according to a second aspect of the present invention is a composition, in particular a precursor granulate; further advantageous embodiments of this aspect of the invention are disclosed.

Again, a further subject-matter of the present invention is the use of a composition, also disclosed.

Another further subject-matter of the present invention according to a fourth aspect of the present invention is a process for the production of a precursor granulate.

Finally, according to a fifth aspect of the present invention, a further subject-matter of the present invention is a three-dimensional object containing silicon carbide.

It goes without saying that the particular features mentioned in the following, in particular special embodiments or the like, which are only described in relation to one aspect of the invention, also apply in relation to the other aspects of the invention, without this requiring any express mention.

Furthermore, for all relative or percentage, in particular weight-related, quantities or amounts stated below, it is to be noted that, within the framework of this invention, these are to be selected by the person skilled in the art in such a way that the sum of the ingredients, additives or auxiliary substances or the like always results in 100 percent or 100 percent by weight This, however, goes without saying for the person skilled in the art

In addition, the skilled person may deviate from the values, ranges or quantities listed below, depending on the application and individual case, without leaving the scope of this invention.

In addition, all of the parameters specified below or the like can be determined by standardized or explicitly specified determination methods or by common determination methods known per se by the person skilled in the art.

### BRIEF DESCRIPTION OF THE DRAWINGS

FIG. 1 provides a cross-section along an xy plane of an apparatus for carrying out the method according to the invention, and

FIG. 2 provides an enlarged section from FIG. 1, which in particular represents the three-dimensional object produced.

### DETAILED DESCRIPTION OF THE INVENTION

With this provision made, the subject-matter of the present invention is explained in more detail in the following.

Subject-matter of the present invention—according to a first aspect of the present invention—is thus a process for the production of three-dimensional objects, in particular workpieces, from silicon carbide-containing compounds by means of additive manufacturing, wherein the silicon carbide-containing compounds are obtained from a precursor granulate by selective, in particular site-selective, energy input.

The method according to the invention allows in particular the simple production of almost any silicon carbide-containing materials—in particular from non-stoichiometric silicon carbides to silicon carbide-containing alloys for high-performance ceramics.

The present invention also permits the generation of high-resolution and detailed three-dimensional structures, i.e. the course of edges is highly precise and, in particular, free of burrs. Within the scope of the present invention, it is also possible to obtain compact solids which do not have a porous structure but consist of crystalline silicon carbide-containing materials. The materials and three-dimensional objects available with the inventive method thus have almost the same material properties as crystalline silicon carbide compounds.

Through the use of generative manufacturing processes, it is also possible within the scope of the present invention to produce three-dimensional structures in supported construction, especially in a powder bed process. In particular, the precursor granulate that is not exposed to the effects of energy, in particular laser radiation, can still be used, i.e. the method according to the invention can be carried out almost without unwanted residual materials. In particular, the method according to the invention allows a very fast and low-cost production of three-dimensional silicon carbide-containing objects and, in particular, does not require the application of pressure in order to provide compact non-porous or less porous materials.

In the context of the present invention, a compound containing silicon carbide is a binary, ternary or quaternary inorganic compound whose empirical formula contains silicon and carbon. In particular, a compound containing silicon carbide does not contain molecularly bonded carbon, such as carbon monoxide or carbon dioxide; rather, the carbon is present in a solid structure.

In the context of the present invention, it is particularly intended that the precursor granulate is not a powder mixture, in particular a mixture of different precursor powders and/or granulates. It is a special feature of the inventive method that a homogeneous granulate, in particular a precursor granulate, is used as starting material for additive manufacturing. In this way, the precursor granulate can transfer into the gas phase or the precursor compounds can react to the desired target compounds by means of short exposure times to energy, in particular laser radiation. Thus, individual particles of different in-organic substances with particle sizes in the μm range do not have to be sublimated and their constituents then do not have to diffuse to form the corresponding compounds and alloys. The homogeneous precursor granulate used within the scope of the present invention guarantees that the individual components, in particular elements, of the silicon carbide-containing target compound are homogeneously distributed and arranged in the immediate vicinity of one another, i.e. less energy is required to produce the silicon carbide-containing compounds.

According to a preferred embodiment of the present invention, the precursor granulate is obtainable from a precursor solution or a precursor dispersion, in particular a precursor sol. The precursor granulate is thus preferably obtained from a finely divided liquid, in particular from a solution or dispersion, preferably using a sol-gel process. In this way, a homogeneous distribution of the individual components, in particular precursor compounds, can be achieved in the granulate, whereby preferably the stoichiometry of the silicon carbide-containing material to be produced is already preformed.

The conversion to the target compounds can occur in many different ways. It is advantageous, however, if the precursor compounds are cleaved under the effect of energy, in particular under the effect of a laser beam, and are transferred into the gas phase as reactive particles. Since the special composition of the precursor ensures that silicon and carbon as well as any dopant or alloying elements are immediately adjacent in the gas phase, the silicon carbide sublimating at 2,300° C. or the doped silicon carbide or the silicon carbide alloy are deposited. Crystalline silicon carbide in particular absorbs laser energy much worse than the precursor granulate and conducts heat very well, so that a locally strictly limited deposition of the defined silicon carbide compounds takes place. On the other hand, undesired components of the precursor compound form stable gases, such as CO₂, HCl, H₂O etc., that can be removed via the gas phase.

If the precursor granulate is available from a solution or dispersion, in particular a gel, the precursor granulate is obtained by drying the precursor solutions or dispersions or the resulting gel.

As far as the particle sizes of the precursor granulate are concerned, these can vary within wide ranges depending on the respective chemical compositions, the laser energy used and the properties of the material or object to be produced. In general, however, precursor granulates comprise particle sizes in the range from 0.1 to 150 μm, in particular from 0.5 to 100 μm, preferably from 1 to 100 μm, more preferably from 7 to 70 μm, particularly preferably from 20 to 40 μm.

Particularly good results are obtained in the context of the present invention if the particles of the precursor granulate have a D60 value in the range from 1 to 100 μm, in particular from 2 to 70 μm, preferably from 10 to 50 μm, more preferably from 21 to 35 μm. The D60 value for the particle size represents the limit below which the particle size of 60% of the precursor granulate particles lies, i.e. 60% of the precursor granulate particles have particle sizes which are smaller than the D60 value.

In this context, it can also be envisaged that the precursor granulate has a bimodal particle size distribution. In this way, precursor granulates with an in particular high bulk density are accessible.

As already explained above, the inventive method is suitable for the production of a large spectrum of compounds containing silicon carbide. In the context of the present invention, the silicon carbide-containing compound is usually selected from non-stoichiometric silicon carbides and silicon carbide alloys. In the context of the present invention, a non-stoichiometric silicon carbide compound means a silicon carbide which does not contain carbon and silicon in a molar ratio of 1:1, but in different proportions. Usually, a non-stoichiometric silicon carbide shows a molar excess of silicon in the context of the present invention.

Silicon carbide alloys in the context of this invention relate to compounds of silicon carbide with metals such as titanium or other compounds such as zirconium carbide or boron nitride, which contain silicon carbide in different and strongly varying proportions. Silicon carbide alloys often form high-performance ceramics, which are characterized by special hardness and temperature resistance.

The inventive method can therefore be used universally and is suitable for the production of a large number of different silicon carbide compounds, in particular to adjust their mechanical properties.

If a non-stoichiometric silicon carbide is obtained within the scope of the present invention, the non-stoichiometric silicon carbide is usually a silicon carbide of the general formula (I)

SiC₁₋ₓ (I)

with

x=0.05 to 0.8, in particular 0.07 to 0.5, preferably 0.09 to 0.4, more preferably 0.1 to 0.3.

Such silicon-rich silicon carbides have a particularly high mechanical load-bearing capacity and are suitable for a variety of applications as ceramics.

If the silicon carbide-containing compound obtained within the scope of this invention is a silicon carbide alloy, the silicon carbide alloy is usually selected from MAX phases, alloys of silicon carbide with elements, especially metals, and alloys of silicon carbide with metal carbides and/or metal nitrides. Such silicon carbide alloys contain silicon carbide in varying and strongly fluctuating proportions. In particular, it may be that silicon carbide comprises the main component of the alloys. However, it is also possible that the silicon carbide alloy contains only small amounts of silicon carbide.

Usually, the silicon carbide alloy contains silicon carbide in amounts of 10 to 95% by weight, in particular 15 to 90% by weight, preferably 20 to 80% by weight, relative to the silicon carbide alloy.

In the context of the present invention, a MAX phase in particular means carbides and nitrides which crystallize in hexagonal layers and have the general formula Mₙ₊₁AXₙ with n=1 to 3. M represents an early transition metal from the third to sixth group of the periodic system of the elements, while A represents an element from the 13th to 16th group of the periodic system of the elements. X is either carbon or nitrogen. In the context of the present invention, however, only such MAX phases are of interest whose empirical formula contains silicon carbide (SiC), i.e. silicon and carbon.

MAX phases exhibit unusual combinations of chemical, physical, electrical and mechanical properties as these exhibit both metallic and ceramic behavior depending on the conditions. This includes, for example, high electrical and thermal conductivity, high loading capacity at thermal shock, very high hardness and low coefficients of thermal expansion.

If the silicon carbide alloy is a MAX phase, it is preferred if the MAX phase is selected from Ti₄SiC₃ and Ti₃SiC.

In particular, the MAX phases mentioned above are highly resistant to chemicals and oxidation at high temperatures in addition to the properties described before.

If the silicon carbide containing compound is an alloy of silicon carbide, it has been proven that, if the alloy is an alloy of silicon carbide with metals, it is advantageous if the alloy is selected from alloys of silicon carbide with metals from the group of Al, Ti, V, Cr, Mn, Co, Ni, Zn, Zr and their mixtures.

If the alloy of silicon carbide is selected from alloys of silicon carbide with metal carbides and/or metal nitrides, it has been proven well if the alloys of silicon carbide with metal carbides and/or metal nitrides are selected from the group of boron carbides, especially B₄C, chromium carbides, in particular Cr₂ C₃, titanium carbides, in particular TiC, molybdenum carbides, in particular Mo₂C, niobium carbides, in particular NbC, tantalum carbides, in particular TaC, vanadium carbides, in particular VC, zirconium carbides, in particular ZrC, tungsten carbides, in particular WC, boron tride, in particular BN, and mixtures thereof.

As far as the inventive method-conduction is concerned, it has been proven successful if the method is carried out in a protective gas atmosphere, in particular a nitrogen and/or argon atmosphere, preferably an argon atmosphere. The method according to the invention is generally carried out in a protective gas atmosphere so that in particular carbon-containing precursor compounds are not oxidized. If the process is carried out in an argon atmosphere, it is usually also an inert gas atmosphere, since argon does not react with the precursor compounds under the process conditions. If nitrogen is used as protective gas, silicon nitrides can also be formed. This can be desired, for example, if the silicon carbide is additionally mix-doped with nitrogen.

However, if the incorporation of nitrogen into the silicon carbide or into the silicon carbide-containing compound is not desired, the process according to the invention is carried out in an argon atmosphere.

With regard to the temperatures at which the method according to the invention is carried out, it has been proven successful if the precursor granulate is heated to temperatures in the range of 1,600 to 2,100° C., in particular 1,700 to 2,000° C., preferably 1,700 to 1,900° C., at least in certain areas, by the input energy. At the aforementioned temperatures, all precursor components pass into the gas phase and the precursor compounds are decomposed to the desired reactive species, which then react to the target compounds.

In the context of the present invention, it is usually intended that the energy input is effected by radiation energy, in particular by laser radiation.

As far as the resolution of the site-selectively introduced energy is concerned, it has been proven successful if the energy input, in particular by means of laser radiation, takes place with a resolution of 0.1 to 150 μm, in particular 1 to 100 μm, preferably 10 to 50 μm. In this way, it is possible to produce particularly contrast-rich and sharply limited or detailed objects from the precursor granulate. The resolution of the input energy, in particular of a laser beam, usually represents the lower limit of the resolving power for interfaces and details of the manufactured object Alternatively, the energy input can also be limited site-selectively by the use of masks. However, the use of laser beams is preferred. The resolution of the energy input is to be understood as the minimum width of the energy input area. It is usually limited by the cross-sectional area of the laser beam or the dimensioning of the mask.

In accordance with a particularly preferred embodiment of the present invention, the additive manufacturing is carried out using a method similar to Selective Laser Melting (SLM): Selective Synthetic Crystallisation (SSC). In Selective Synthetic Crystallization (SSC), an object is not produced from the melt but from the gas phase. The apparatus design and the conduct of Selective Synthetic Crystallization corresponds to Selective Laser Melting, i.e. the same devices can be used for Selective Synthetic Crystallization under very similar conditions as for Selective Laser Melting. By laser radiation, the energy required to transfer the starting material into the gas phase can be introduced into the precursor granulate.

According to a preferred embodiment of the inventive method, the method is carried out as a multi-stage method. In this context, it is planned in particular that
(a) in a first method step, the precursor granulate is provided in the form of a layer, in particular in the form of a film,
(b) in a second method step following the first method step (a), the precursor granulate is converted into a silicon carbide-containing compound by the effect of energy, in particular at least in certain regions, so that a layer of the three-dimensional object is produced, and
(c) in a third method step following the second method step (b), a further layer, in particular a film, of the precursor granulate is applied to the in the second method step (b), in particular at least partially, converted layer of the precursor granulate,
   wherein the method steps (b) and (c) are repeated until the three-dimensional object is completed. In particular, it is also intended here that process step (b) is carried out following process step (c).

The method according to the invention is thus carried out in particular as a so-called powder bed method, in which the three-dimensional object to be manufactured is produced layer by layer from a powder by the selective input of energy. In order to produce the three-dimensional object, a three-dimensional representation of the object to be produced is usually generated by means of computer technology, in particular as a CAD file, which is translated into a corresponding layer attachment and then successively, i.e. layer by layer, is generated by means of additive manufacturing, in particular by means of Selective Synthetic Crystallization. In this way, the finished three-dimensional object is finally obtained.

A special feature of the method according to the invention is to be seen in particular in the fact that it works without subsequent sintering steps, i.e. within the scope of the present invention the precursors are selected and in particular adjusted to the Selective Synthetic Crystallization in such a way that directly from the gas phase a homogeneous, compact three-dimensional object is obtained which does not have to be subjected to sintering.

All the above-mentioned advantages, features and embodiments can be applied accordingly to the preferred embodiment of the present invention described above; the above-mentioned advantages, features and special embodiments can also be transferred in particular onto the above-mentioned multi-stage method.

As far as the provision of precursor granulate in the powder bed is concerned, this can be done with different layer thicknesses. Usually, however, a layer, in particular a film, of the precursor granulate has a thickness, in particular a film thickness, of 1 to 1,000 μm, in particular 2 to 500 μm, preferably 5 to 250 μm, more preferably 10 to 180 μm, particularly preferably 20 to 150 μm, most preferably 20 to 100 μm. With thicknesses of the layers, in particular film thicknesses, in the previously mentioned areas for the precursor granulate, detailed three-dimensional objects with a high resolution can be produced.

According to an alternative embodiment of the present invention, the additive manufacturing of the silicon carbide-containing object to be produced can take place on a substrate, e.g. a carrier plate or a complex-shaped object, which is later replaced by the silicon carbide-containing object. Similarly, the substrate can also consist of a workpiece to which the additively manufactured object remains firmly attached. In this way, additional layers and structures can be applied to existing objects using the method described here. As substrates or existing objects, workpieces made of materials with a relatively high melting point and with a material structure that guarantees a relatively good bond with silicon carbide are particularly suitable. Silicon carbide and silicon carbide-containing compounds, ceramic materials and metals are the most suitable substrate materials for these applications. In this way, it is possible, for example, to produce objects from silicon carbide alloys which have layers with different properties or, for example, to apply layers of materials containing silicon carbide to metals, e.g. tool steel.

In order to apply precursors to complex substrates in a suitable manner and to transform them into silicon carbide-containing compounds, in particular with a laser, it may be intended, according to a preferred embodiment of the present invention, to selectively apply very small quantities of precursor granulate using a suitable arrangement, in particular a granulate jet, and to process it immediately with the laser, in accordance with a process known as “build-up welding” in additive manufacturing with metals.

The figures show in accordance with

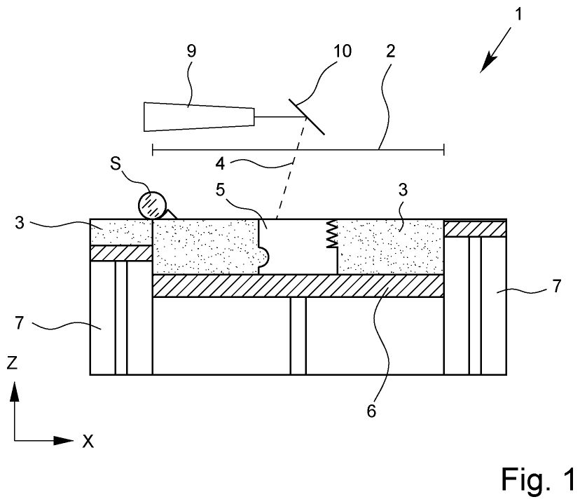

FIG. 1 a cross-section along an xy plane of an apparatus for carrying out the method according to the invention, and

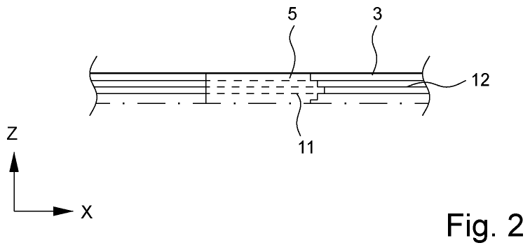

FIG. 2 an enlarged section from FIG. 1, which in particular represents the three-dimensional object produced.

Further a subject-matter of the present invention—according to a second aspect of the present invention—is a composition, in particular in the form of a granulate, preferably in the form of a precursor granulate, containing

at least one silicon source,

at least one carbon source, and

optionally, precursors of alloy elements.

In the context of the present invention, a silicon source or a carbon source means compounds which, under the process conditions of the generative manufacturing method, can release silicon or carbon in such a way that compounds containing silicon carbide are formed. In this context, silicon and carbon do not have to be released in elementary form, but it is sufficient if they react under the process conditions to silicon carbide-containing compounds.

The silicon source, the carbon source or the precursors for the alloying elements can either be precursor compounds used directly or, for example, their reaction products, especially hydrolysates, as described below.

In the context of the present invention, the silicon source is usually selected from silane hydrolysates and silica and mixtures thereof. In the context of the present invention, the silicon source, i.e. the precursor of the silicon in the silicon carbide-containing compound, is obtained in particular by hydrolysis of tetraalkoxysilanes, so that the silicon in the precursor granulate is preferably present in the form of silicic acid or silane hydrolysates.

As far as the carbon source is concerned, this is usually selected from the group of sugars, in particular sucrose, glucose, fructose, invert sugar, maltose; starch; starch derivatives and organic polyols, in particular phenol formaldehyde resin, resorcinol formaldehyde resin, and mixtures and/or reaction products thereof, in particular sugars and/or reaction products thereof. Particularly preferred is the carbon source selected from sugars and reaction products thereof, preferably using sucrose and/or invert sugar and/or reaction products thereof. Also, in the case of the carbon source, not only the actual reagent but also its reaction products can be used.

If the composition is used to produce a non-stoichiometric silicon carbide, the composition usually contains
(A) the silicon source in amounts of 60 to 90% by weight, in particular 65 to 85% by weight, preferably 70 to 80% by weight, and
(B) the carbon source in amounts of 10 to 40% by weight, in particular 15 to 35% by weight, preferably 20 to 30% by weight,
   each based on the composition.

Compositions comprising the carbon source and the silicon source in the above-mentioned amounts are excellent for the reproducible production of non-stoichiometric silicon carbides with an excess of silicon.

If the composition is used to produce a silicon carbide alloy, the composition usually contains
(A) the silicon source in amounts of 5 to 40% by weight, in particular 5 to 30% by weight, preferably 10 to 20% by weight,
(B) the carbon source in amounts of 10 to 60% by weight, in particular 15 to 50% by weight, preferably 20 to 50% by weight, and
(C) one or more precursors of alloy elements in amounts of 5 to 70% by weight, in particular 5 to 65% by weight, preferably 10 to 60% by weight,
   each based on the composition.

According to a preferred embodiment of the present invention, the composition is obtainable from a precursor solution or a precursor dispersion. In this context, it is particularly preferred if the composition is obtainable by a sol-gel process. In sol-gel processes, solutions or fine-particle solid-in-liquid dispersions are usually produced, which are converted into a gel containing larger solid particles as a result of subsequent aging and the respective condensation processes.

After drying of the gel, a particularly homogeneous composition, in particular a suitable precursor granulate, can be obtained within the context of the present invention, with which the desired silicon carbide-containing compounds can be obtained under the effect of energy in additive manufacturing when a suitable stoichiometry is selected.

According to a particular embodiment of the present invention, it is intended that the composition is converted to a reduced composition by thermal treatment under reductive conditions. The reductive thermal treatment usually takes place in an inert gas atmosphere, in which in particular the carbon source, preferably a sugar-based carbon source, reacts with oxides or other compounds of silicon as well as possible further compounds of other elements, through which the elements are reduced and volatile oxidized carbon and hydrogen compounds, in particular water and CO₂, are formed, which are removed via the gas phase.

For further details on the composition according to the invention, reference is made to the above explanations relating to the inventive method, which apply correspondingly to the inventive composition.

A further subject-matter of the present invention—according to a third aspect of the present invention—is the use of a composition previously described for the production of a three-dimensional object containing silicon carbide, in particular by means of generative manufacturing methods, preferably additive manufacturing.

For further details on the inventive use, reference is made to the above explanations on the other aspects of the invention, which apply accordingly to the inventive use.

Another object of the present invention—according to a fourth aspect of the present invention—is a method for preparing a composition, in particular a precursor granulate, where
(i) in a first method step, a solution or dispersion, in particular a sol, containing
(I) at least one silicon-containing compound,
(II) at least one carbon-containing compound,
(III) at least one solvent or dispersant and
(IV) optionally, alloying reagents,
   is produced,
(ii) in a second method step following the first method step (i), the solution or dispersion is reacted, in particular is aged to a gel, and
(iii) in a third method step following the second method step (ii), the reaction product from the second method step (ii), in particular the gel, is dried and, optionally, comminuted.

In the context of the present invention, a solution means a single-phase system in which at least one substance, in particular a compound or its building blocks, such as ions, are homogeneously distributed in another substance. In the context of the present invention, a dispersion is understood to mean an at least biphasic system in which a first phase, namely the dispersed phase, is distributed in a second phase, the continuous phase. The continuous phase is also known as the dispersion medium. Especially in the case of sols or polymeric compounds, the transition from a solution to a dispersion is often fluent, so that it is no longer possible to distinguish clearly between a solution and a dispersion.

As far as the selection of the solvent or dispersant in method step (i) is concerned, this can be selected from all suitable solvents or dispersants. Usually, however, in method step (i) the solvent or dispersant is selected from water and organic solvents and their mixtures, preferably their mixtures. Particularly in mixtures containing water, inorganic hydroxides, in particular metal hydroxides and silicas, are often formed by hydrolysis of the starting compounds, which then condense so that the method can be carried out in the form of a sol-gel process.

The present invention may also include that the solvent is selected from alcohols, in particular methanol, ethanol, 2-propanol, acetone, ethyl acetic ester and their mixtures. It is particularly preferred in this context if the organic solvent is selected from methanol, ethanol, 2-propanol and their mixtures, with ethanol being preferred in particular.

The organic solvents mentioned above can be mixed with water in a wide range and are particularly suitable for dispersing or dissolving polar inorganic substances.

As mentioned above, mixtures of water and at least one organic solvent, in particular mixtures of water and ethanol, are preferably used as solvents or dispersants within the scope of the present invention. In this context, it is preferred if the solvent or dispersant has a weight-related ratio of water to organic solvent of 1:10 to 20:1, in particular 1:5 to 15:1, preferably 1:2 to 10:1, more preferably 1:1 to 5:1, particularly preferably 1:3. The ratio of water to organic solvent can be used on the one hand to adjust the hydrolysis rate, in particular of the silicon-containing compound and the alloying reagents, and on the other hand to adjust the solubility and reaction rate of the carbon-containing compound, in particular of the carbon-containing precursor compound, such as sugars.

In the context of the present invention, it is preferred if, in the method for preparing the composition in method step (i), the silicon-containing compound is selected from silanes, silane hydrolysates, orthosilicic acid and mixtures thereof, in particular silanes. In the context of this invention, orthosilicic acids and their hydrolysis products can be obtained, for example, from alkali silicates whose alkali metal ions have been exchanged for protons by ion exchange. However, alkali metal compounds are not used in the present invention as far as possible, since they are incorporated into the resulting composition, in particular the precursor granulate, especially when a sol-gel process is used, and can therefore also be found in the silicon carbide compound. However, an alkali metal doping is generally not desired within the scope of the present invention. However, if this should be desired, suitable alkali metal salts, for example of the silicon-containing compound or also alkali phosphates, can be used.

Particularly good results are obtained in the context of the present invention when silanes, especially tetraalkoxysilanes and/or trialkoxyalkylsilanes, preferably tetraethoxysilane, tetramethoxysilane or triethoxymethylsilane, are used as silicon-containing compounds in method step (i), since these compounds react via hydrolysis in aqueous medium to orthosilicic acids or their condensation products or highly cross-linked siloxanes and the corresponding alcohols.

As far as the carbon-containing compound is concerned, it has proven successful if in method step (i) the carbon-containing compound is selected from the group of sugars, in particular sucrose, glucose, fructose, invert sugar, maltose; starch; starch derivatives and organic polymers, in particular phenol formaldehyde resin, resorcinol formaldehyde resin, and mixtures thereof. Particularly good results are obtained in the context of the present invention if the carbon-containing compound is used in an aqueous solution or dispersion in method step (i).

If the carbon-containing compound is used, in particular, in an aqueous solution or dispersion, the carbon-containing compound is usually placed in a small quantity of the solvent or dispersant, in particular water, intended for the preparation of the composition in method step (i). Particularly good results are obtained in this context if the carbon-containing compound is used in a solution containing the carbon-containing compound in amounts of 10 to 90% by weight, in particular 30 to 85% by weight, preferably 50 to 80% by weight, in particular 60 to 70% by weight, based on the solution or dispersion of the carbon-containing compound.

In particular, it is also possible that catalysts, in particular acids or bases, may be added to the solution or dispersion of the carbon-containing compound in order, for example, to accelerate the inversion of sucrose and achieve better reaction results.

As far as the temperatures are concerned, at which method step (i) is carried out, it has proven successful if method step (i) is carried out at temperatures in the range of 15 to 40° C., in particular 20 to 30° C., preferably 20 to 25° C.

In the context of the present invention, it is preferably intended that in method step (ii) the temperatures are raised slightly in comparison with method step (i) in order to accelerate the reaction of the individual components of the solution or dispersion, in particular the condensation reaction during the ageing of the sol to the gel.

Particularly good results are obtained in this context when method step (ii) is carried out at temperatures in the range of 20 to 80° C., in particular 30 to 70° C., preferably 40 to 60° C. In this context, it has proven to be particularly effective if method step (ii) is carried out at 50° C.

Regarding the time period over which method step (ii) is carried out, this can vary depending on the respective temperatures, the solvents employed and the precursor compounds used. However, process step (ii) is usually carried out over a period of 15 minutes to 20 hours, in particular 30 minutes to 15 hours, preferably 1 to 10 hours, more preferably 2 to 8 hours, most preferably 2 to 5 hours. Within the above time periods a complete reaction of the sol to a gel is usually observed if the method is performed as a sol-gel process.

Concerning the quantities of the individual components in method step (ii) to each other, these may vary widely depending on the intended use. For example, the precursor compositions for non-stoichiometric silicon carbides comprise completely different compositions and proportions of the individual components than compositions intended for the production of silicon carbide alloys.

When selecting the individual compounds, in particular the doping reagents or alloying reagents, it also needs to be ensured that these can be processed into homogeneous granulates with a carbon source and a silicon source, which can react in generative manufacturing processes to silicon carbide-containing compounds.

In particular, it is preferable to ensure that the alloying reagents are decomposed or split during generative manufacturing, in particular Selective Synthetic Crystallization, in such a way that the desired elements de-sublimize as reactive particles to the desired alloy, while the remaining constituents of the compound react as far as possible to stable gaseous substances, such as water, CO, CO₂, HCl, etc., which can be easily removed via the gas phase. In addition, the compounds used should have sufficiently high solubilities in the solvents used, in particular in ethanol and/or water, in order to be able to form finely divided dispersions or solutions, in particular sols, and should not react with other constituents of the solution or dispersion, in particular sol, to form insoluble compounds during the manufacturing process. In addition, the reaction rate of the individual reactions must be adjusted to each other, since hydrolysis, condensation and especially gelation must take place undisturbed prior to granulate formation. The reaction products formed should not be sensitive to oxidation and should not be volatile.

If a precursor granulate for the preparation of a non-stoichiometric silicon carbide, in particular a silicon carbide with an excess of silicon, is to be prepared by the method according to the invention, then, in method step (i), the solution or dispersion contains the silicon-containing compound in amounts of 20 to 70% by weight, in particular 25 to 65% by weight, preferably 30 to 60% by weight, more preferably 40 to 60% by weight, based on the solution or dispersion.

In this case it may also be provided that the solution or dispersion contains the carbon-containing compound in amounts of 5 to 40% by weight, in particular 10 to 35% by weight, preferably 10 to 30% by weight, more preferably 12 to 25% by weight, based on the solution or dispersion.

In addition, it may be provided that, in the case that a non-stoichiometric silicon carbide is to be prepared, the solution or dispersion in method step (i) contains the solvent or dispersant in amounts of 30 to 80% by weight, in particular 35 to 75% by weight, preferably 40 to 70% by weight, more preferably 40 to 65% by weight, based on the solution or dispersion.

If a composition for the production of a silicon carbide alloy is to be provided within the context of the present invention, it has proven successful if, in method step (i), the solution or dispersion contains the silicon-containing compound in amounts of 1 to 80% by weight, in particular 2 to 70% by weight, preferably 5 to 60% by weight, more preferably 10 to 30% by weight, relative to the composition.

According to this embodiment, it may also be provided that the solution or dispersion contains the carbon-containing compound in amounts of 5 to 50% by weight, in particular 10 to 40% by weight, preferably 15 to 40% by weight, more preferably 20 to 35% by weight, based on the solution or dispersion.

According to this embodiment, it may similarly be provided that the solution or dispersion in method step (i) contains the solvent or dispersion agent in amounts of 10 to 60% by weight, in particular 15 to 50% by weight, preferably 15 to 40% by weight, more preferably 20 to 40% by weight, relative to the solution or dispersion.

In addition, it may be provided according to this embodiment that the solution or dispersion in method step (i) contains the alloying reagent in amounts of 5 to 60% by weight, in particular 10 to 45% by weight, preferably 15 to 45% by weight, more preferably 20 to 40% by weight, based on the solution or dispersion.

In the context of the present invention, it is particularly preferred if the alloying reagent is selected from the corresponding chlorides, nitrates, acetates, acetylacetonates and formates of the corresponding alloy elements.

As far as the conduct of method step (iii) is concerned, it has proven successful to dry the reaction product from method step (ii) in method step (iii) at temperatures in the range of 50 to 400° C., in particular 100 to 300° C., preferably 120 to 250° C., more preferably 150 to 200° C. The reaction product from method step (ii) can be dried at temperatures in the range of 100 to 300° C., in particular 120 to 250° C., preferably 150 to 200° C.

As far as the time required for drying is concerned, this can vary over a wide range. However, it has proven reliable if the reaction product in method step (iii) is dried for a period of 1 to 10 hours, in particular 2 to 5 hours, preferably 2 to 3 hours.

In addition, it is possible that the reaction product is comminuted in method step (iii), in particular after the drying process. In this context, it is particularly preferred if the reaction product is mechanically comminuted in method step (iii), in particular by grinding. The particle sizes required or advantageous for carrying out the generative manufacturing process, in particular Selective Synthetic Crystallization, can be specifically adjusted by the grinding process. However, it is often sufficient to mechanically stress the reaction product from method step (ii) during the drying process, for example by stirring, in order to adjust the desired particle sizes.

In accordance with a particular embodiment of the present invention, in a fourth method step (iv) following method step (iii), the composition obtained in method step (iii) is subjected to a reductive thermal treatment so that a reduced composition is obtained. The use of a reduced composition which has undergone a reductive treatment has the advantage that a large number of possible and interfering by-products have already been removed. The resulting reduced precursor granulate is even more compact and contains higher proportions of the elements forming the silicon carbide-containing compound.

If a reductive thermal treatment of the composition obtained in method step (iii) is carried out following method step (iii), it has proven successful if, in method step (iv), the composition obtained in method step (iii) is heated to temperatures in the range from 700 to 1,300° C., in particular 800 to 1,200° C., preferably 900 to 1,100° C.

In this context, particularly good results are obtained when the composition obtained in method step (iii) in method step (iv) is heated for a period of 1 to 10 hours, in particular 2 to 8 hours, preferably 2 to 5 hours. In the specified temperature ranges and reaction times described, in particular a carbonization of the carbon-containing precursor material can take place, which can significantly facilitate the subsequent reduction, particularly of metal compounds.

In general, method step (iv) is carried out in a protective gas atmosphere, in particular in an argon and/or nitrogen atmosphere. This in particular prevents oxidation of the carbon-containing compound.

If, within the scope of the present invention, the reductive thermal treatment of the precursor granulate described above is envisaged in order to obtain a reduced composition, in particular a reduced precursor granulate, then the precursor compounds may not evaporate at the applied temperatures of up to 1,300° C., preferably up to 1,100° C., but may selectively decompose under the reductive thermal conditions into compounds which can be specifically converted into the desired silicon carbide-containing compounds during manufacturing, in particular by means of Selective Synthetic Crystallization.

For further details on the method for the preparation of a composition according to the invention, reference is made to the above explanations relating to the other aspects of the invention, which apply analogously to the inventive method.

Finally, a subject-matter of the present invention—according to a fifth aspect of the present invention—is a silicon carbide-containing three-dimensional object which is obtainable by the aforementioned method and/or by using an aforementioned composition.

For further details on this aspect of the invention, reference is made to the above explanations relating to the other aspects of the present invention, which apply analogously to the three-dimensional object according to the invention.

In the following, the subject matter of the present invention will be explained in a non-restrictive manner by means of the figures on the basis of preferred embodiments.

FIG. 1 shows a section through an apparatus for the generation of the three-dimensional silicon carbide-containing objects according to the invention by means of Selective Laser Sintering along an xy plane.

In an xy plane, which is perpendicular to an xz plane, apparatus 1 has a construction field whose construction field extension 2 in x direction is shown in FIG. 1. On the construction field, a three-dimensional object is generated from a powdery composition 3, in particular a precursor granulate described above, by selective radiation of laser beams 4. The construction field is designed to be at least partially movable in z-direction by the piston 6, in particular along a z-axis, which is perpendicular to the xy-plane. In the embodiment depicted in the figure, the entire construction site is movable over its extension 2, in particular the entire extension of the construction field in x- and y-direction, through the piston 6. However, it is also possible that, according to an alternative embodiment not shown in the figure, only selected areas of the construction field can be moved in the z-direction, i.e. along a z-axis. Areas of the construction field can thus be designed in the form of stamps, for example, which can be moved independently in the z-direction, so that selected areas of the construction field can be moved in the z-direction.

The construction field shown in the figure shows a powder bed of the inventive composition 3, in particular the inventive precursor granulate. Adjacent to the construction site, storage facilities 7 are provided for the reception and delivery of composition 3. In accordance with the embodiment shown in the figure, the storage devices 7 are provided with pistons movable in the z-direction, in particular along a z-axis, so that by moving the piston in the z-direction, either a space is created in the storage device 7 for receiving the composition 3 or the composition is pressed out of the storage device 7, in particular into the area of the construction field.

Composition 3 is distributed after discharge from the storage device 7 by a distribution device 8 in a homogeneous uniform layer on the construction field, whereby excess composition 3 can always be taken up in an opposite storage device 7. The distribution device 8 is shown in the figure representation in the form of a roller.

The apparatus 1 has means for generating laser beams in which laser beams 4 are generated. The laser beams 4 can be deflected onto the construction field via deflection means 10, in particular at least one mirror arrangement, so that the three-dimensional object 5 is obtained there.

When carrying out the inventive method for the production of three-dimensional objects containing silicon carbide, a thin layer of composition 3 is now placed on the construction site and subsequently heated and melted or split into its components by selective spatially resolved radiation of laser beams 4 generated in the means for generating laser beams 9 and deflected via the deflecting means 10, so that a layer of a compound containing silicon carbide is obtained.

The construction field area is then lowered at least slightly with the aid of the piston 6 and further composition 3 is delivered from a supply device 7, which is homogeneously distributed on the construction field in the form of a thin layer with the distribution device 8.

This creates a new layer of composition 3 which can then be irradiated. Excess composition 7 is resumed in the opposite storage facility 7.

Subsequently, the laser beams 4 irradiate and heat the layer in a site-selective manner, resulting in a new layer of the three-dimensional object 5 made of a silicon carbide-containing material. By repeating these process steps, the three-dimensional object 5 is finally built up.

FIG. 2 shows an enlarged section of the construction site, in particular FIG. 2 shows the different layers 11 of silicon carbide-containing material, which form the three-dimensional object 5. The illustration of the individual layers 11 is made only to clarify the present invention, the individual layers are usually not recognizable on the three-dimensional object 5, since homogeneous objects made of silicon carbide-containing material are obtained by the method described.

Reference signs:

| | |
|---|---|
| 1 | apparatus |
| 2 | construction field extension |
| 3 | powdery composition |
| 4 | laser beams |
| 5 | three-dimensional object |
| 6 | piston |
| 7 | storage device |
| 8 | distribution device |
| 9 | means for generating |
| | laser beams |
| 10 | deflection means |
| 11 | layers |

1. Method for the production of three-dimensional objects, in particular workpieces, from compounds containing silicon carbide by means of additive manufacturing,
characterized in that
the silicon carbide-containing compounds are obtained from a precursor granulate by selective, in particular site-selective, energy input.

2. Method according to claim 1, characterized in that the precursor granulate is obtainable from a precursor solution or a precursor dispersion, in particular a precursor sol.

3. Method according to claim 1, characterized in that the precursor granulate comprises particles with particle sizes in the range from 0.1 to 150 μm, in particular from 0.5 to 100 μm, preferably from 1 to 100 μm, more preferably from 7 to 70 μm, particularly preferably from 20 to 40 μm.

4. Method according to claim 1, characterized in that the particles of the precursor granulate have a D60 value in the range from 1 to 100 μm, in particular from 2 to 70 μm, preferably from 10 to 50 μm, more preferably from 21 to 35 μm.

5. Method according to claim 1, characterized in that the silicon carbide-containing compound is selected from non-stoichiometric silicon carbides and silicon carbide alloys.

6. Method according to claim 1, characterized in that the energy input is effected by means of radiation energy, in particular by laser radiation.

7. Method according to claim 6, characterized in that the energy input is effected with a resolution of 0.1 to 150 μm, in particular 1 to 100 μm, preferably 10 to 50 μm.

8. Method according to claim 1, characterized in that the manufacturing method, in particular the additive manufacturing, involves selective synthetic crystallization.

9. Method according to claim 1, characterized in that
(a) in a first method step, the precursor granulate is provided in the form of a layer, in particular in the form of a film,
(b) in a second method step following the first method step (a), the precursor granulate is converted into a silicon carbide-containing compound by the effect of energy, in particular at least in certain regions, so that a layer of the three-dimensional object is produced, and
(c) in a third method step following the second method step (b), a further layer, in particular a film, of the precursor granulate is applied to the in the second method step (b), in particular at least partially, converted layer of the precursor granulate,
wherein the method steps (b) and (c) are repeated until the three-dimensional object is completed.

10. Method according to claim 9, characterized in that a layer, in particular a film, of the precursor granulate has a thickness, in particular film thickness, of 1 to 1,000 μm, in particular 2 to 500 μm, preferably 5 to 250 μm, more preferably 10 to 180 μm, particularly preferably 20 to 150 μm, most preferably 20 to 100 μm.

11. Composition, in particular in the form of a granulate, preferably a precursor granulate, containing
at least one silicon source,
at least one carbon source, and
optionally, precursors of alloy elements.

12. Composition according to claim 11, characterized in that the silicon source is selected from silane hydrolysates and silica and mixtures thereof.

13. Composition according to claim 11, characterized in that the carbon source is selected from the group of sugars, in particular sucrose, glucose, fructose, invert sugar, maltose; starch; starch derivatives and organic polymers, in particular phenol formaldehyde resin, resorcinol formaldehyde resin, and mixtures thereof, in particular sugars, preferably sucrose and/or invert sugar, and/or reaction products thereof.

14. Composition according to one of claims 11, characterized in that the composition is obtainable from a precursor solution, in particular by a sol-gel method.

15. Composition according to one of claims 11, characterized in that the composition has been converted into a reduced composition by thermal treatment under reductive conditions.

16. Use of a composition according to one of claims 11, for the production of a silicon carbide-containing three-dimensional object, in particular by means of generative manufacturing methods.

17. Method for the preparation of a composition, in particular a precursor granulate, characterized in that
(i) in a first method step, a solution or dispersion, in particular a sol, containing
(I) at least one silicon-containing compound,
(II) at least one carbon-containing compound,
(III) at least one solvent or dispersant and
(IV) optionally, doping and/or alloying reagents,
is produced,
(ii) in a second method step following the first method step (i), the solution or dispersion is reacted, in particular is aged to a gel, and
(iii) in a third method step following the second method step (ii), the reaction product from the second method step (ii), in particular the gel, is dried and, optionally, comminuted.

18. A silicon carbide-containing three-dimensional object obtainable by a method according to claim 1 and/or by using a composition according to claim 11.
